(19) United States
(12) Patent Application Publication
(10) Pub. No.: US 2015/0042424 A1
(43) Pub. Date: Feb. 12, 2015

(54) OPERATING MECHANISM AND POWER SWITCH PROVIDED WITH THE OPERATING MECHANISM

(71) Applicant: Kabushiki Kaisha Toshiba, Minato-ku (JP)

(72) Inventors: Yutaka MARUYAMA, Fuchu (JP); Satoshi MARUSHIMA, Kawasaki (JP); Yoshiaki OHDA, Yokohama (JP); Katsumi SUZUKI, Yokohama (JP)

(73) Assignee: Kabushiki Kaisha Toshiba, Minato-ku (JP)

(21) Appl. No.: 14/523,019

(22) Filed: Oct. 24, 2014

Related U.S. Application Data
(63) Continuation of application No. PCT/JP2013/002744, filed on Apr. 23, 2013.

(30) Foreign Application Priority Data
Apr. 26, 2012 (JP) 2012-101692

(51) Int. Cl. H01H 50/64

(52) U.S. Cl. CPC H01H 50/641
USPC 335/179

(57) ABSTRACT

A power switch operating mechanism comprises: a series of external permanent magnets, a series of internal permanent magnets, an internal pipe, an external pipe, a three-phase coil, an output ring and a power supply lead. In the series of external permanent magnets, the magnets are juxtaposed in such a way that their magnetic poles are rotated by a maximum of 90° in each case. In the series of internal permanent magnets, the magnetic poles have magnetization vector radial components that are in the same direction as that of the series of external permanent magnets and magnetization vector, axial components that are in the opposite direction to that of the series of external permanent magnets. The series of external permanent magnets and the series of internal permanent magnets are fixed so that their magnetization vector radial components are in the same direction. The three-phase coil is interposed with a fixed clearance between the series of external permanent magnets and the series of internal permanent magnets.

### CROSS-REFERENCE TO RELATED APPLICATION

This is a Continuation of PCT Application No. PCT/JP2013/002744, filed on Apr. 23, 2013, which is based upon and claims the benefit of priority from the prior Japanese Patent Application No. 2012-101692, filed on Apr. 26, 2012, the entire contents of which are incorporated herein by reference.

### FIELD

An embodiment of the present invention relates to an electromagnetic drive type operating mechanism that operates a movable contact and a power switch (or sometimes also called a power switchgear) provided with this operating mechanism.

### BACKGROUND

A power switch comprises a pair of contacts and performs switching of an electrical circuit by joining or separating these contacts. When a fault current is detected, the power switch inputs a cut-off signal and, prompted by this cut-off signal, the power switch opens the contacts to cut off the current.

Such a power switch typically comprises a pair of arc contacts and, in addition, a puffer chamber or voltage boosting chamber. The arc contacts take over the arc discharge by being separated as the circuit switching contacts are separated. The puffer chamber or voltage boosting chamber is constituted by a piston and cylinder and compresses the gas detained in the chamber by relative movement of the cylinder and piston, with the result that high-pressure gas from inside and outside the chamber is injected between the contacts. The arc discharge is extinguished by this injection of high-pressure gas, completing current cut-off.

The operating mechanism is provided in order to perform respective relative movement of the movable contacts for switching this electrical circuit, the arc movable contacts, and the piston or cylinder. It is therefore desirable that this operating mechanism should be capable of being driven in a manner that can be freely selected, should be capable of high-speed movement of the movable elements thereof, and should have excellent response of the movable elements thereof.

The reason why the operating mechanism should be capable of being driven in a manner that can be freely selected is that, since the fault current is AC and its voltage fluctuates cyclically, and the phase at which the fault occurs is random, it is desirable that the cut-off operation should be performed with suitable timing to facilitate cut-off, taking into account the state transition involved in arc extinction after generation of a fault current. The reason why the operating mechanism should be capable of high-speed movement and should have excellent response of the movable elements thereof is that the cut-off action must be completed in the short time of a few tens of msec from start of the cut-off instruction.

Furthermore, in addition to these aspects concerning drive performance, because of progress which has been made with regard to underground installation of power equipment and the provision of a drive mechanism, restricted size of the operating mechanism and ease of maintenance are being demanded.

Types of operating mechanism that have currently been proposed include the air type, hydraulic type, spring type or electromagnetic drive type. The hydraulic type is a type in which a movable element is driven using a hydraulic actuator. The spring type is a type in which the movable element is driven using the energy obtained when a spring is released: this is the type which is currently chiefly employed. The electromagnetic drive type is a type in which the movable element is driven by an electromagnetic actuator.

Of these, an example of the electromagnetic drive type is the type in which the movable contact is driven by converting the motive power of a rotary electrical machine to linear motion: examples are Laid-open Japanese Patent Application Number Tokkai 2009-212372 (hereinafter referred to as Patent Reference 1) or Laid-open Japanese Patent Application Number Tokkai 2008-021599 (hereinafter referred to as Patent Reference 2). With this system, any desired type of drive can be achieved by controlling drive of the rotary electrical machine.

Also, there may be mentioned, as examples of the use of electromagnetic attractive force or electromagnetic repulsion force as direct thrust, a system in which the attractive force of an electromagnet and permanent magnet is employed. An example is: Laid-open Japanese Patent Application Number Tokkai 2003-016888 (hereinafter referred to as Patent Reference 3). Or, as a system utilizing electromagnetic attractive force or repulsive force acting on an air-cored coil, there may be mentioned for example Laid-open Japanese Patent Application Number Tokkai H 10-040782, Laid-open Japanese Patent Application Number Tokkai 2002-124158 (hereinafter referred to as Patent References or 4 and 5). Also, as a system utilizing induced repulsive force, there may be mentioned for example Laid-open Japanese Patent Application Number Tokkai 11-025817 (hereinafter referred to as Patent Reference 6). An air-cored coil has the characteristic advantage that, since the time constant of the electrical circuit is small, fast response is obtained in the initial operation period.

A method of driving such an air-cored coil has also been proposed, in which cylindrical permanent magnets are employed that are arranged internally and externally, maintaining a mutually fixed separation, and an exciting current is applied to an air-cored coil located between these internal and external cylindrical permanent magnets. An example is issued Japanese Patent Number 4625032 (hereinafter referred to as Patent Reference 7).

Various types of such electromagnetic drive-type operating mechanisms have been proposed, but it has been remarked that they are inferior in regard to thrust, which is indispensable for high-speed closure of the movable contacts and high-speed cut-off, compared with hydraulic-type operating mechanisms or spring-type operating mechanisms.

Specifically, although, in the example employing a rotary motor illustrated in Patent References 1 and 2, it was proposed to employ a core (magnetic core) in the winding of the rotary motor in order to obtain high torque, this resulted in high inductance, increasing the time constant of the electrical circuit and therefore imposing limitations on the degree to which response could be improved. Thus there is a trade-off between thrust and response.

Also, in the systems in which electromagnetic attraction electromagnetic repulsion is directly employed as thrust as in Patent References 3 to 2, it is difficult to achieve a fully selectable level of drive in all operating regions, so it is difficult to perform cut-off operation with the appropriate timing to facilitate cut-off.

In the system using an actuator in which cylindrical permanent magnets are arranged as shown in Patent Reference 7, a fully selectable level of drive can be achieved and, since no core is employed in the coil, the inductance can be kept at a comparatively low level. However, even though a core is not employed in the interior of the coil, magnetic rings are arranged at both ends of the ring-shaped coil, so an appreciable increase in inductance may be caused.

Also, since the direction of magnetization of both the internal and external cylindrical permanent magnets is uniformly in the same radial direction, the magnetic flux generated from the internal and external cylindrical permanent magnets follows a path from the outside face of the external cylindrical permanent magnet, through the lower bottom and upper bottom of the cylinder, passing through the inside face of the internal cylinder, and returning again to the external cylindrical permanent magnet. In order to make the flow of this magnetic flux smooth and create a more powerful magnetic flux, and in order to avoid the external effects of the magnetic field, a back yoke must be employed comprising a cylindrical-shaped magnetic body, outside the external cylindrical permanent magnet and inside the internal cylindrical permanent magnets.

In this case, an internal back yoke of course has the same effect as a core in relation to the coil, and an external back yoke also has the same effect. There is therefore the problem that the inductance of the coil becomes large.

In addition, a powerful permanent magnet must be used in order to increase the thrust and the back yoke must be made thick in order to avoid magnetic saturation of the back yoke. For this reason, even if a powerful permanent magnet is employed, it is difficult to reduce the volume/thrust ratio.

In other words, even in the case of the proposed system of Patent Reference 7, it was not possible to satisfy requirements with respect to response and/or thrust.

As stated above, with an electromagnetic drive type operating mechanism, albeit the required indispensable functionality was provided, it was difficult to satisfy requirements with respect to high speed and fast response. The present invention was made in order to solve this problem, its object being to provide a power switch operating mechanism and power switch provided therewith of high speed and fast response, having the necessary indispensable functionality.

In order to achieve the above object, the present invention is constructed as follows. Specifically, a power switch operating mechanism for moving a switch device between a cut-off condition and a closed condition by reciprocating drive of a movable contact comprises: a series of first permanent magnets; a series of second permanent magnets; magnet fixing means; a coil; coil support means; and a power supply lead.

In addition, this first permanent magnet series is configured so that these permanent magnets are juxtaposed in such a way that the magnetic poles of ring-shaped or arcuate-shaped permanent magnets are rotated by a maximum of 90° in each case in the cross-section including the central axis thereof. The second permanent magnet series is configured so that the magnetic poles of ring-shaped or arcuate-shaped permanent magnets have a magnetization vector radial component in the same direction as the series of the first permanent magnets or have a magnetization vector axial component in the opposite direction to that of the series of the first permanent magnets. The magnet fixing means fixes the series of the first permanent magnets and the series of the second permanent magnets so that the magnetization vector radial components of their respective magnetic poles face in the same direction. The coil is interposed between the first permanent magnet series and the second permanent magnet series with a fixed clearance. The coil support means is directly or indirectly linked with the movable contact so that the coil is fixed and is capable of parallel movement along the series of the first and second permanent magnets. The power supply lead supplies power for exciting the coil.

In this way, the thrust for reciprocating drive of the movable contact is generated by the action of the excited coil and the magnetic circuit generated by the first permanent magnet series and the second permanent magnet series.

### BRIEF DESCRIPTION OF THE DRAWINGS

FIG. 1 is an internal constructional diagram showing a power switch according to a first embodiment;

FIG. 2 is a perspective view showing an external view of an operating mechanism;

FIG. 3 is a cross-sectional view along the axis of the operating mechanism;

FIG. 4 is a cross-sectional view orthogonal to the axis of the operating mechanism;

FIG. 5 is a constructional diagram of a drive device;

FIG. 6 is a constructional diagram showing a transmission mechanism and a first holding mechanism;

FIG. 7 is a constructional diagram showing a second holding mechanism;

FIG. 8 is an internal constructional diagram showing a power switch according to a second embodiment;

FIG. 9 is a constructional diagram showing an example construction of a second transmission mechanism;

FIG. 10 is a constructional diagram showing another example construction of a second transmission mechanism; and

FIG. 11 is a constructional diagram showing a first holding mechanism according to a third embodiment.

### DETAILED DESCRIPTION OF THE PREFERRED EMBODIMENTS

### First Embodiment

### Overall Construction

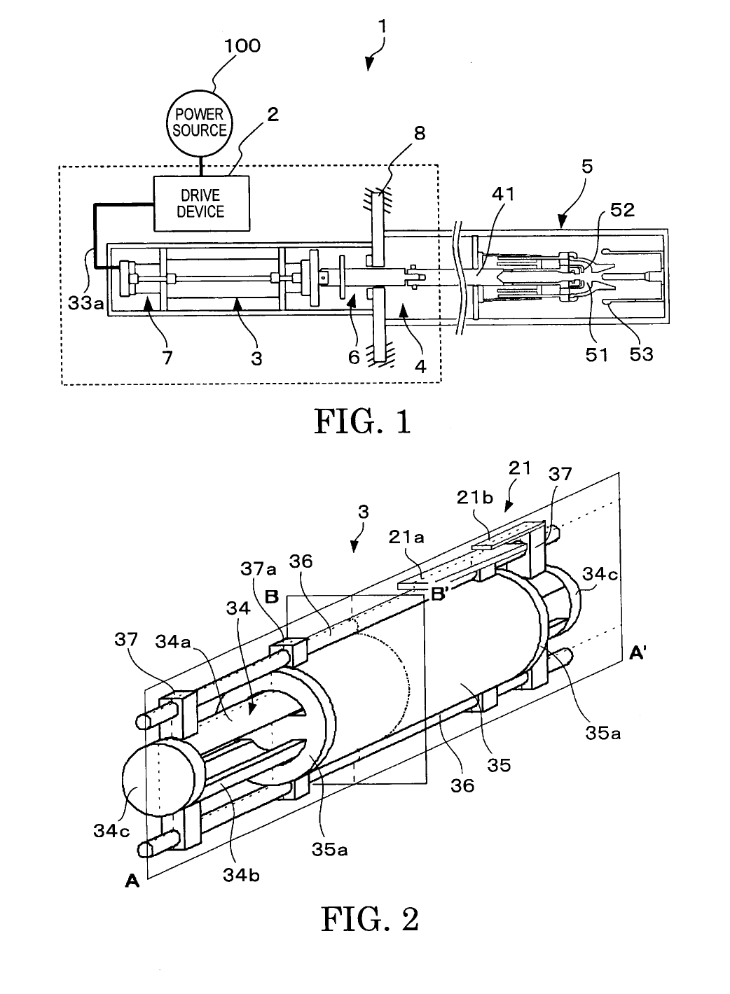

FIG. 1 is an internal constructional diagram showing a power switch according to a first embodiment. The power switch 1 is a device for opening/closing an electrical circuit and comprises: a drive device 2; an operating mechanism having a transmission mechanism 4, a first holding mechanism 6, a second holding mechanism 7; and a switch mechanism 5.

The drive device 2 drives the operating mechanism 3 by supplying the power delivered from the power source 100 to the operating mechanism 3. The operating mechanism 3 is an operating mechanism that generates thrust in a linear direction (an axial direction). The transmission mechanism 4 has an operating rod 41 that is movable in the axial direction and thrust generated by the operating mechanism 3 is transmitted to the switch mechanism 5 by pushing/pulling this operating rod 41.

In the switch mechanism 5, a movable contact 52 and a fixed contact 53 are arranged within a sealed space 51 that is filled with arc-extinguishing gas; also the movable contact 52 is fixed to the operating rod 41 and the movable contact 52 can be brought into contact with or separated from the fixed contact 52 in response to pushing/pulling the operating rod 41. The first holding mechanism 6 and the second holding mechanism 7 maintain a contact condition of the movable contact. 52 and the fixed contact 53 during the current-connected condition, in which thrust has not been generated by the operating mechanism 3.

(Operating Mechanism)

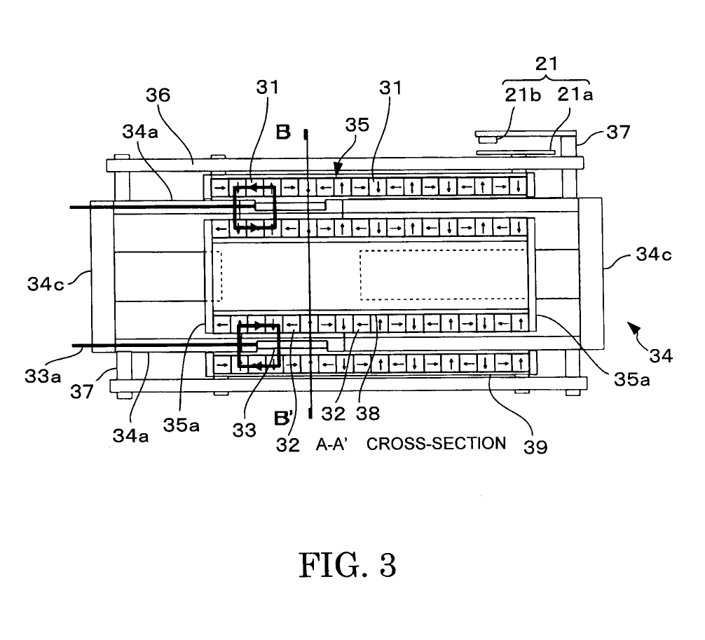

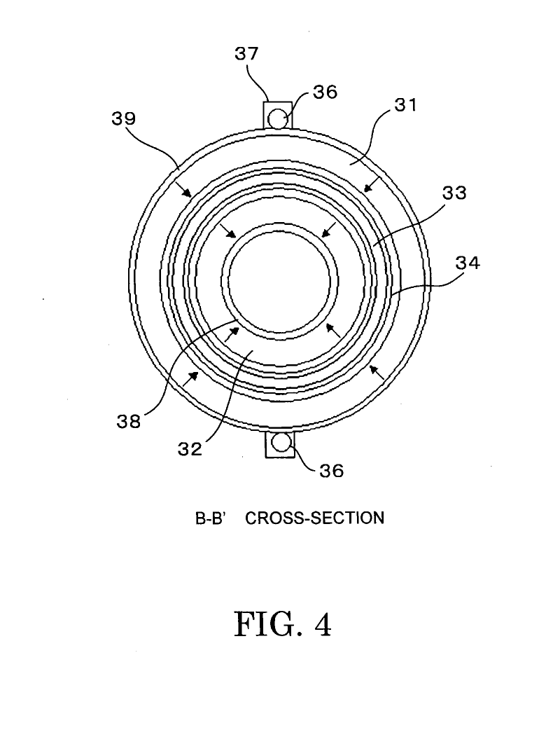

FIGS. 2 to 4 are views showing the detailed construction of the operating mechanism 3: FIG. 2 is a perspective view showing the external appearance of the operating mechanism 3; FIG. 3 is a cross-sectional view along the line A-A′ along the central axis of the operating mechanism 3; and FIG. 4 is a cross-sectional view along the line B-B′ orthogonal to the central axis of the operating mechanism 3. As shown in FIG. 2 to FIG. 4, the operating mechanism 3 causes the output ring 34, on which is wound the three-phase soil 33, to be extended/retracted in the axial direction by excitation of the three-phase coil 33 and the magnetic field that is generated by the series of external permanent magnets 31 and the series of internal permanent magnets 32 whose magnetization energy is held approximately equal.

As shown in FIG. 2, basically, this operating mechanism 3 comprises a stator 35, in addition to the output ring 34. The stator 35 has a cylindrical shape. The output ring 34 constitutes a coil support means for the three-phase coil 33 and is formed of non-magnetic material, having a shape with a pair of elongate arcuate-shaped plates 34a facing each other with their arc centers coincident, in other words, a shape in which partial facing locations of the peripheral wall of the cylinder are cut away along the axis.

The stator 35 is fixed to the ground. The diameter of the output ring 34 is smaller than the diameter of the stator 35 and the output ring 34 is supported so as to be capable of axial movement within the stator 35. Specifically, a pair of rod-shaped guide bars 36 that are longer than the stator 35 are laid along the axis of the stator 35 on the outer peripheral surface of the stator 35 and a connection member 37 is fixed to the output ring 34 by fixing of both ends of these guide bars 36 to the connection member 37. In addition, a guide 37a is provided on the guide bars 36, being slidably fitted onto the guide bars 36, so that the guide 37a is fixed to the stator 35.

It should be rioted that both ends of the stator 35 are covered by a disk 35a that is formed of non-magnetic material. Also, the pair of arcuate-shaped plates 34a, 34b of the output ring 34 are linked, while maintaining the same attitude, by a disk 34c that is fixed to both ends. Furthermore, the output ring 34 is longer than the stator 35 and the disk 35a is formed with a hole through which the output ring 34 passes, matching the shape of the arcuate-shaped plates 34a, 34b.

Also, this operating mechanism 3 is provided with a position sensor 21 that detects the relative position of the three-phase coil 33 with respect to the series of external permanent magnets 31. The position sensor 21 is constituted by a linear scale 21a and an optical pickup 21b. The optical pickup 21b is mounted on one of the connection members 37 that moves together with the output ring 34, so that the direction of orientation of the detected and emitted light faces the side of the guide bars 36. The linear scale 21a is mounted along the guide bar 36, facing the optical pickup 21b.

Within this operating mechanism 3, a three-phase coil 33 is wound on the output ring 34 as shown in FIGS. 3 and 4. The location of winding is recessed from the surface, but not to a depth such as to pierce this ring; the three-phase coil 33 is coplanar with or below the external peripheral surface of the output ring 34. The power supply lead 33a of the three-phase coil 33 passes from the disk 34c through the interior of the peripheral wall of the output ring 34.

The series of external permanent magnets 31 and the series of internal permanent magnets 32 are arranged along the axial direction on either side of the peripheral wall of the output ring 34. A fixed clearance is provided between the peripheral wall of the output ring 34 and the series of external permanent magnets 31 and the series of internal permanent magnets 32.

The internal permanent magnets 32 are of arcuate shape or ring shape and a plurality of these internal permanent magnets 32 are juxtaposed in the axial direction of an internal pipe 38, which is formed of non-magnetic material, by being fitted thereon so that their internal diameter follows the external diameter of the internal pipe 38. Thus this internal pipe 38 constitutes an example of magnet fixing means for fixing the internal permanent magnets 32. This internal pipe 38 is coaxial with the output ring 34, being arranged at a fixed position in the interior of the output ring 34.

The external permanent magnets 31 are arcuate-shaped or ring-shaped and a plurality of these external permanent magnets 31 are juxtaposed in the axial direction of the internal pipe 38, being stuck on so that their external diameter follows the internal diameter of an external pipe 39, which is formed of non-magnetic material. Thus this external pipe 39 constitutes an example of magnet fixing means for fixing the external permanent magnets 31. This external pipe 39 is coaxial with the output ring 34, and the position of the output ring 34 inside the external pipe 39, they keep a certain distance each other.

These internal permanent magnets 32 and external permanent magnets 31 are juxtaposed respectively as a Halbach array. In this embodiment, the permanent magnets are adjacently arranged so as to be rotated in each case by a maximum of 90°, in a cross-section, for example the section A-A′, containing the central axis of the output ring 34.

Also, the rotational directions of the magnetization direction are inverted in the series of internal permanent magnets 32 and the series of external permanent magnets 31. In other words, for example, the direction of magnetization seen in sequence along the series of external permanent magnets 31 follows a clockwise rotation, whereas the direction of magnetization seen in sequence along the series of internal permanent magnets 32 follows an anticlockwise rotation, in FIG. 3.

In addition, these internal permanent magnets 32 and external permanent magnets 31 are arranged so as to face each other in one-to-one fashion, with the peripheral wall of the output ring 34 therebetween. Internal permanent magnets 32 and external permanent magnets 31 having a magnetization vector with a radial component in the same direction face each other and internal permanent magnets 32 and external permanent magnets 31 having a magnetization vector with an axial component in the opposite direction face each other. These radial directions and axial directions are directions defined with respect to the arcuate shape or ring-shape constituted by the external permanent magnets 31 and internal permanent magnets 32.

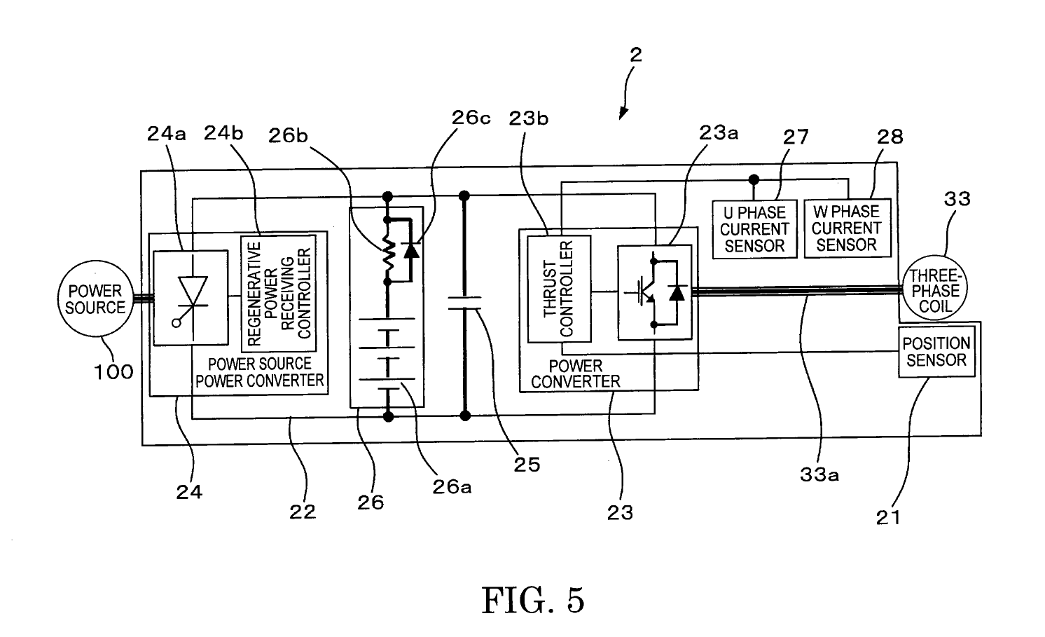

FIG. 5 is a constructional diagram of the drive device 2. The drive device 2 comprises a power converter 23 and power source power converter 24 that exchange power through a bus 22. Also, a smoothing capacitor 25 and an accumulator device (battery) 26 constituting power storage means are connected with the bus 22.

The smoothing capacitor 25 and accumulator device 26 suppress voltage fluctuations of the bus 22 to a low level even during power consumption by the three-phase coil 33 and power regeneration from the three-phase coil 33. Such smoothing capacitors 25 and/or accumulator devices 26 may be suitably provided at a plurality of locations on the bus 22.

Also, in the accumulator device 26, there are arranged a battery 26a, resistor 26b and diode 26c. The resistor 26b and the diode 26c are connected with the positive electrode side of the battery 26a and the resistor 26b and diode 26c are connected in parallel. In more detail, in order to suppress overcharging of the battery 26a, the device is constituted so that, during power supply from the battery 26a, no power is dissipated by the resistor 26b, but, during charging of the battery 26a, part of the charging power is dissipated by the resistor 26b.

The power converter 23 comprises a PWM (Pulse Width Modulation) inverter 23a that supplies AC current to the three-phase coil 33 through the power supply lead 33a and a thrust controller 23h that controls the PWM inverter 23a. The thrust controller 23b controls the PWM inverter 23a so that a thrust equal to the thrust instruction value that is input from outside the drive device 2 is generated in the three-phase coil 33. For example, the PWM inverter 23a may comprise a group of power conversion elements and the thrust controller 23b may control the ignition angle of these power conversion elements.

This thrust controller 23b is connected with at least a U phase current sensor 27 and W phase current sensor 28 and position sensor 21. The U phase current sensor 27 and the W phase current sensor 28 detect the exciting current of the U phase and W phase, of the U, V and W phases of the three-phase coil 33. The thrust controller 23h performs thrust control by referring to the signal from the U phase current sensor 27 and W phase current sensor 28 and position sensor 21.

The power source power converter 24 comprises an inverter 24a and regenerative power receiving controller 24b. The regenerative power receiving controller 24h recovers power stored in the smoothing capacitor 25 and battery 26a to the power source 100, in response to a regenerative power receiving instruction signal from outside, and controls the angle of ignition of the inverter 24a in order to store the power from the power source 100.

(First Holding Mechanism)

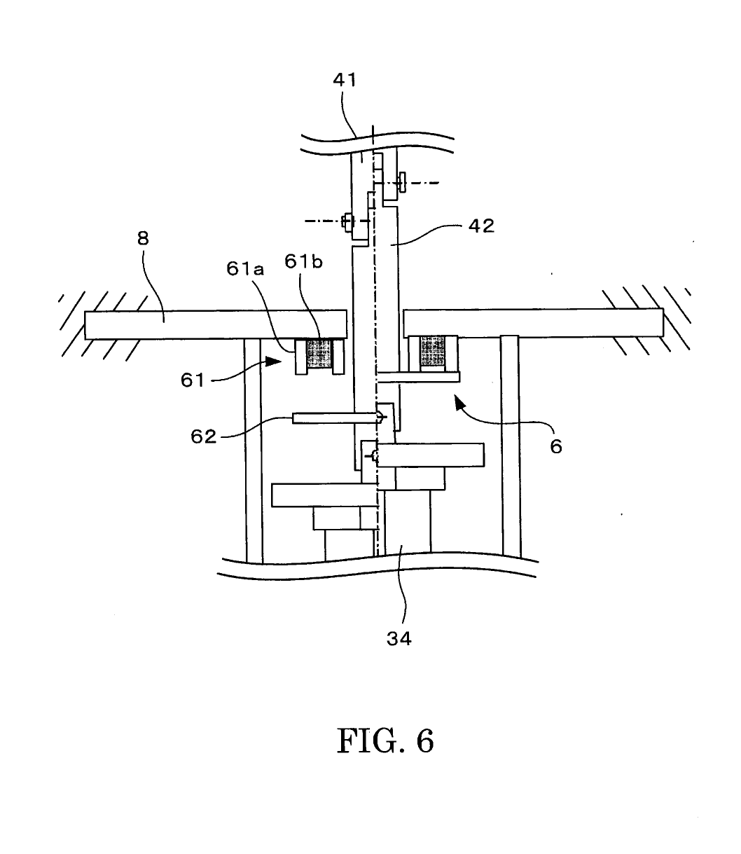

FIG. 6 is a constructional diagram showing the transmission mechanism 4 and the first holding mechanism 6: the left-hand half of the Figure shows the cut-off condition and the right-hand half shows the closed condition. It should be noted that, although, in this embodiment, the case is described in which the first holding mechanism 6 maintains the closed condition, it would be possible, using the same construction, for the first holding mechanism 6 to maintain a cut-off condition.

A further intermediate rod 42 is connected between the operating rod 41 of the transmission mechanism 4 and the output ring 34. One end of this intermediate rod 42 and one end of the output ring 34 are rotatably journalled by means of a shared pin. Also, the other end of the intermediate rod 42 and one end of the operating rod 41 are rotatably journalled by means of a shared pin. Journalled pin between the intermediate rod 42 and the output ring 34 is orthogonal to a journalled pin between the operating rid 41 and the intermediate rod 42.

Next, with movement of the operating rod 41 provided in the transmission mechanism 4, the first holding mechanism 6 maintains the contacting condition of the movable contact 52 and the fixed contact 53 by magnetic attraction of a target 62 such as to approach the magnet unit 61.

This target 62 is a plate-shaped member formed of a ferromagnetic body, that is erected at the peripheral face of the intermediate rod 42. The intermediate rod 42 is passed through a frame 8 that is fixed to the ground; the magnet unit 61, which is constituted of a yoke 61a formed of a ferromagnetic body, and a permanent magnet 61b, is fixed in the vicinity of a hole in the frame 8, through which the intermediate rod 42 passes, so as to face the target 62.

Regarding the positional relationship of the magnet unit 61 and the target 62, the magnet unit 61 is on the side of the switch mechanism 5 and the target 62 is on the side of the output ring 34. Essentially, these two items are positioned such that when the operating rod 41 moves in a direction such as to bring the movable contact 52 into contact with the fixed contact 53, the target 62 approaches the magnet unit 61. It should be noted that the same effect could be obtained even if the positional relationship of the magnet unit 61 and the target 62 is inverted.

(Second Holding Mechanism)

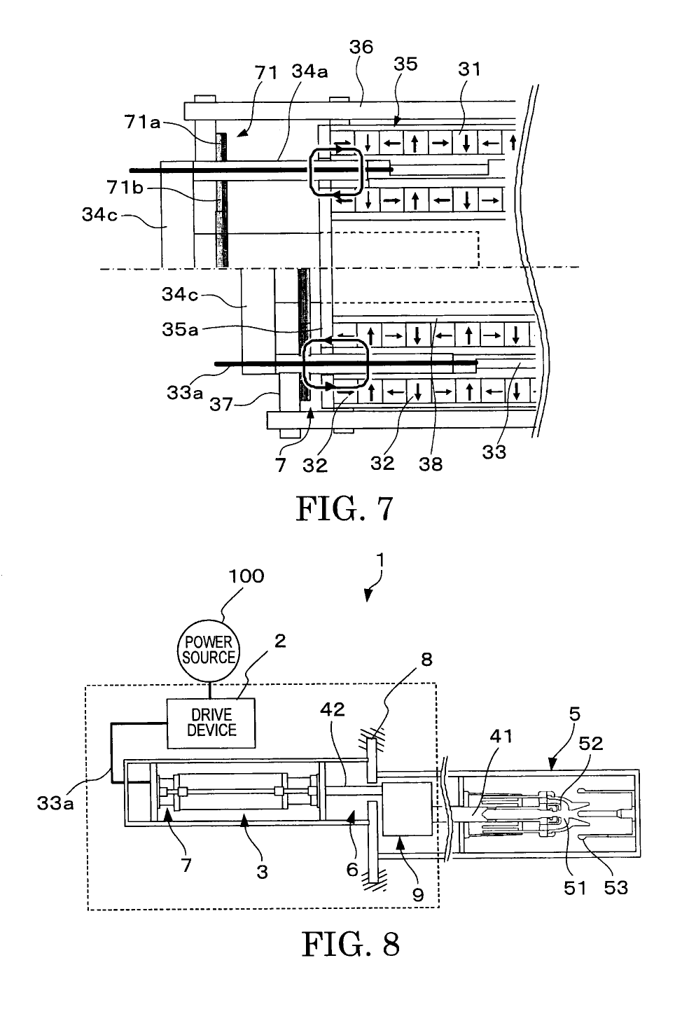

FIG. 7 is a constructional diagram showing the second holding mechanism 7, the upper half of the Figure showing the cut-off condition and the lower half of the Figure showing the closed condition. It should be noted that, although, in this embodiment, description was given using an example in which the second holding mechanism 7 maintained the closed condition, it would be possible to maintain a cut-off condition using the same mechanism. This second holding mechanism 7 comprises a target 71 and external permanent magnets 31 and internal permanent magnets 32 that generate magnetic attractive force with respect to this target 71.

The target 71 is a plate that is formed of a ferromagnetic body that is fixed in the output ring 34. This target. 71 comprises an outer ring 71a and a ring 71b. The outer ring 71a is formed with an internal diameter such as to follow the external diameter of the output ring 34 and is erected from the outer peripheral surface of the output ring 34 by fitting therein so as to follow the outer peripheral surface of the output ring 34. The inner ring 71b is formed with an external diameter such as to follow the internal diameter of the output ring 34 and is erected inwards from the inner peripheral face of the output ring 34 by being stuck on so as to follow the inner peripheral surface of the outer ring 34. The positions of the outside ring 71a and the inside ring 71b in the length direction of the output ring 34 coincide.

In the closed condition, the position of the output ring 34 to which the target 71 is fixed is also maintained by the action of leakage magnetic flux of the external permanent magnets 31 and internal permanent magnets 32 on the target 71.

(Action)

The operation and action of a power switch 1 constructed as above will now be described. When the operating mechanism 3 is in a stationary condition, no thrust at all is output to the movable contact 52 of the switch mechanism 5. In this condition, the movable contact 52 is moved towards the fixed contact 53 and the movable contact 52 and fixed contact 53 are thus in contact.

In this closed condition of the current, as shown in the right-hand half of FIG. 6, the target 62 is in contact with the magnet unit 61. Consequently, the magnetic attractive force of the magnet unit 61 acts strongly on the target 62, with the result that the target 62 is fixed to the magnet unit 61.

The target 62 and the output ring 34 are in a fixed relationship; the output ring 34 and the movable contact 52 are in a relationship in which they are linked through the intermediate rod 42 and the operating rod 41, so the movable contact 52 is also maintained in the closed position. Consequently, in the condition in which the operating mechanism 3 is stationary, even if an external force such as weight acts on the movable contact 52, the closed condition can be maintained by magnetic force in the first holding mechanism 6 without continued actuation of the operating mechanism 3. As a result, in the first holding mechanism 6 according to the present embodiment, regardless of the mechanical system, power for maintaining the closed condition is not necessary.

It should be noted that contact of the target 62 with respect to the magnet unit 61 refers to a condition in which magnetic attractive force acts to a degree such that the target 62 is fixed to the magnet unit 61 so that the position of the movable contact 52 is maintained: in other words, it also includes a condition in which these are in very close proximity albeit not strictly in contact.

Also, as shown in the bottom half of FIG. 7, in the closed condition of the current, the target 71 is close to or in contact with the external permanent magnets 31 and the internal permanent magnets 32. Consequently, the leakage magnetic flux of the external permanent magnets 31 and the internal permanent magnets 32 acts strongly on the target 71, preventing separating movement of the target 71 with respect to the external permanent magnets 31 and internal permanent magnets 32.

The target 71 and the output ring 34 are in a fixed relationship; the output ring 34 and the movable contact 52 are in a relationship in which they are linked through the intermediate rod 42 and the operating rod 41, so the movable contact 52 is also maintained in the closed position. Consequently, in the condition in which the operating mechanism 3 is stationary, even if an external force such as weight acts on the movable contact 52, the closed condition can be maintained by magnetic force in the second holding mechanism 7 without continued actuation of the operating mechanism 3. As a result, in the second holding mechanism 7 according to the present embodiment, regardless of the mechanical system, power for maintaining the closed condition is not necessary.

Next, if a fault current is generated in the system, a thrust instruction value is input from outside the power switch 1. The thrust instruction value specifies the speed of movement and amount of movement of the movable contact 52. The power converter 23 supplies AC current to the three-phase coil 33 in accordance with the thrust instruction value, through the power supply lead 33a.

Whereas AC current flows in the three-phase coil 33, as shown in FIG. 3, the series of external permanent magnets 31 and the series of external permanent magnets 32 form a magnetic circuit in which the series of external permanent magnets 31 and the series of internal permanent magnets 32 are linked in a ring.

More specifically, the magnetic circuit is formed by linking the magnetic flux in the axial direction passing through the interior of the series of external permanent magnets 31 and the series of internal permanent magnets 32 and the magnetic flux in the radial direction passing through the gap between the external permanent magnets 31 and internal permanent magnets 32. Thus scarcely any of the magnetic flux from the series of external permanent magnets 31 appears at the outside face of the series of external permanent magnets 31 and scarcely any of the magnetic flux of the series of internal permanent magnets 32 appears at the inside face of the series of internal permanent magnet 32. Consequently, the overwhelming majority of the magnetic flux in the radial direction is distributed in the gap between the external permanent magnets 31 and internal permanent magnets 32 i.e. most of the magnetic flux in the radial direction is orthogonally linked with the excited three-phase coil 33. Consequently, the output ring 34, on which the three-phase coil 33 is wound, executes parallel movement between the series of external permanent magnets 31 and the series of internal permanent magnets 32.

When movement of the output ring 34 takes place, the detected values from the position sensor 21, U phase current sensor 27 and W phase current sensor 28 are input to the thrust controller 23b. The thrust controller 23b compares estimated trust value from these detected values with the thrust instruction value and controls the PWM inverter 23a so that the difference (deviation) is zero.

Then, when the detected value obtained by the position sensor 21 reaches the desired value, the thrust controller 23b stops power supply to the three-phase coil 33 from PWM inverter 23a. Whereat, in the switch mechanism 5, the movable contact 52 is separated from the fixed contact 53 and current cut-off is terminated. In this process, preferably a thrust instruction value that varies the velocity and/or the position of the movable contact 52 thereof is input to the thrust controller 23b, so as to suppress contact impact of the target 62 and the magnet unit 61.

Operation in the case of closure of the power switch 1 is the same as in the case of this cut-off operation: when a closure instruction is input to the power switch 1, AC current is applied to the three-phase coil 33, and the closure operation is performed in the same way as the cut-off operation, in the opposite direction to the direction of the cut-off operation, so as to connect the movable contact 52 and the fixed contact 53.

(Beneficial Effect)

As described above, in an operating mechanism 1 for performing mutual movement of a switch device between a cut-off condition and closed condition by reciprocating drive of a movable contact 52 of a power switch 1, in this embodiment, there are provided: a series of external permanent magnets 31, a series of internal permanent magnets 32, an internal pipe 38, an external pipe 39, a three-phase coil 33, an output ring 34 and a power supply lead 33a.

The series of external permanent magnets 31 is constituted by juxtaposing these permanent magnets 31 in such a way that, in a cross-sectional plane containing the central axis thereof, the magnetic poles of the ring-shaped or arcuate-shaped permanent magnets are respectively rotated by, at most, 90°, in each case. In the series of internal permanent magnets 32, the magnetic poles of the ring-shaped or arcuate-shaped permanent magnets have magnetization vector radial components in the same direction as the series of external permanent magnets 31 and have magnetization vector axial components in the opposite direction to the series of external permanent magnets 31.

The internal pipe 38 and the external pipe 39 are fixed facing each other so that the series of external permanent magnets 31 and the series of internal permanent magnets 32 have the magnetization vector radial components of their respective magnetic poles in the same direction. The, three-phase coil 33 is interposed with a fixed clearance between the series of external permanent magnets 31 and the series of internal permanent magnets 32. The output ring 34 has the three-phase coil 33 fixed thereto and is directly or indirectly linked with the movable contact 52: thus the output ring 34 is capable of parallel movement along the series of external permanent magnets 31 and the series of external permanent magnets 32. The power supply lead 33a supplies power for exciting the three-phase coil 33.

In this way, thrust for reciprocating drive of the movable contact 52 can be generated by the action of the excited three-phase coil 33 and the magnetic circuit produced by the series of external permanent magnets 31 and the series of internal permanent magnets 32.

In this process, scarcely any magnetic flux issues from the outside face of the series of external permanent magnets 31 and the inside face of the series of internal permanent magnets 32, so substantially almost of the magnetic flux goes to constitute the magnetic circuit between the outside face of the series of external permanent magnets 31 and the inside face of the series of internal permanent magnets 32. Consequently, a back yoke is unnecessary.

In addition, the series of external permanent magnets 31 and the series of internal permanent magnets 32 hold substantially equal magnetization energies: in this way, the overwhelming majority of the magnetic flux is distributed in the radial direction in the gap between the series of external permanent magnets 31 and the series of internal permanent magnets 32. Furthermore, since the three-phase coil is arranged in the gap where the overwhelming majority of the magnetic flux is distributed in the radial direction, most of the magnetic flux links the three-phase coil 33 orthogonally, so a large thrust is generated with a smaller current. Higher-speed operation can therefore be achieved.

Also, when the operating mechanism 3 is in an operating condition, neither core nor yoke is present in the vicinity of the three-phase coil 33 or the main magnetic flux created by the series of external permanent magnets 31 and the series of internal permanent magnets 32, so the three-phase coil 33 has little self-inductance. Consequently, even if the output ring 34 is operated at high speed, the voltage required for passage of the required exciting current to the three-phase coil 33 is reduced.

Also, the output ring 34 requires neither core nor yoke, so reduction in weight can be achieved and most of the three-phase coil 33 is linked by the main magnetic flux created by the series of internal permanent magnets 31 and internal permanent magnets 32, so the thrust/weight ratio is improved. Consequently, the response performance is also improved.

Furthermore, the target 62 or the permanent magnet 61b are provided that are fixed in position, the target 62 or permanent magnet 61b being fixed to the output ring 34 or to a member that moves in linked fashion with the output ring 34, such as the intermediate rod 42: thus in relative approach of the permanent magnet. 61b and the target 62 in response to movement of the output ring 34, the position of the movable contact 52 is maintained by the magnetic attractive force of the permanent magnet Sib with respect to the target 62.

Also, there is further provided a target 71 that is fixed to the output ring 34, so leakage magnetic flux generated from the series of external permanent magnets 31 and the series of internal permanent magnets 32 acts as a magnetic attractive force on the target 71 so that the position of the movable contact. 52 is maintained.

In this way a mechanical holding mechanism can be dispensed with: this contributes to weight reduction of the device. Consequently the thrust/weight ratio is further improved and response performance is further improved. Furthermore, the fact that, no mechanical, holding mechanism including such a sliding portion is provided and the fact that power for maintaining the closed condition or the cut-off condition is unnecessary are beneficial in that these therefore do not interfere with giving priority to the electromagnetic drive type operating mechanism in terms of maintenance.

Furthermore, since any desired manner of drive of the operating mechanism of this embodiment can be employed, the thrust can be adjusted so as to buffer the impact of the target 62 and the permanent magnet 61b, thereby further reducing the risk of malfunction. Also, since construction designed to reduce the risk of malfunction can be eliminated; further reduction in weight can be achieved.

Also, fixed operating characteristics can be realized, irrespective of the condition of wear of the movable contact 52 and/or fixed contact 53. Furthermore, by comparing the change of drive force necessary to achieve a fixed operating pattern during operation with previous data, the condition of wear of the contacts can be detected, so a diagnostic assessment of the life of the equipment can be performed. Of course, in the periodic inspection, diagnosis can also be performed under no-load operating conditions.

### Second Embodiment

### Overall Construction

FIG. 8 is an internal constructional diagram showing a power switch 1 according to a second embodiment. As shown in FIG. 8, in this power switch 1, a second transmission mechanism 9 is interposed between the intermediate rod 42 and the operating rod 41. This second transmission mechanism 9 can be provided with the object of amplifying the thrust or amplifying the amount of movement.

(Example Construction of the Second Transmission Mechanism)

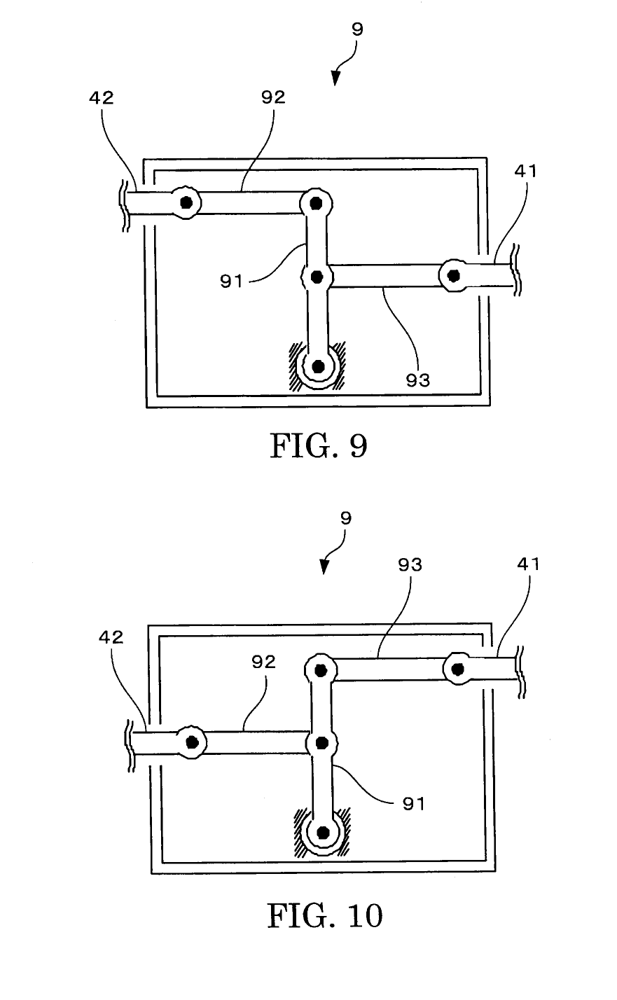

FIG. 9 is a constructional diagram showing a second transmission mechanism 9 with the object of amplifying thrust. As shown in FIG. 9, the second transmission mechanism 9 connects the intermediate rod 42 and the operating rod 41 by interposition of a plurality of links. The plurality of links comprise: a rod-shaped lever 91, one end of which is rotatably fixed; an auxiliary link 92 that rotatably links the intermediate rod 42 and the other end of the lever 91; and an auxiliary link 93 that rotatably links the operating rod 41 and a pivot point provided midway along the lever 91.

(Alternative Example Construction of the Second Transmission Mechanism)

FIG. 10 is a constructional diagram showing a second transmission mechanism 9 with the object of amplifying the amount of movement. As shown in FIG. 10, this second transmission mechanism 9 connects the intermediate rod 42 and the operating rod 41 by interposition of a plurality of links. The plurality of links comprise: a rod-shaped lever 91, one end of which is rotatably fixed; an auxiliary link 92 that rotatably links the intermediate rod 42 and a pivot point provided midway along the lever 91; and an auxiliary link 93 that rotatably links the operating rod 41 and the other end of the lever 91.

(Beneficial Effect)

Thus, there is provided a lever 91 having a rotatable fixed point at one end and with an output ring 34 rotatably mounted directly or indirectly at the other end, and an operating rod 41 mounted at a location closer to the fixed point than that of the output ring 34.

In the case of this second transmission mechanism 9, the distance of the action point with respect to the pivot point (fulcrum point) is closer than in the case of the application point. Consequently, when the lever 91 acts as a lever, the moving force of the intermediate rod 42 is amplified when it is transmitted to the operating rod 41.

Also, there is provided a lever 91 having a rotatable fixed point at one end, with an operating rod 41 rotatably mounted at the other end and an output ring 34 directly or indirectly mounted at a location that is closer to the fixed point than the location of the operating rod 41.

In the case of this second transmission mechanism 9, the distance of the application point with respect to the pivot point is closer than in the case of the action point. Consequently, when the lever 91 acts as a lever, the amount of movement of the intermediate rod 42 is amplified when it is transmitted to the operating rod 41.

Also, although the number of components or sliding portions is increased, since the function is provided of achieving increase/decrease of the thrust or stroke, the benefit is obtained that the degrees of design freedom with respect to the operating mechanism 3 or switch device 5 are increased.

### Third Embodiment

### Construction of First Holding Mechanism

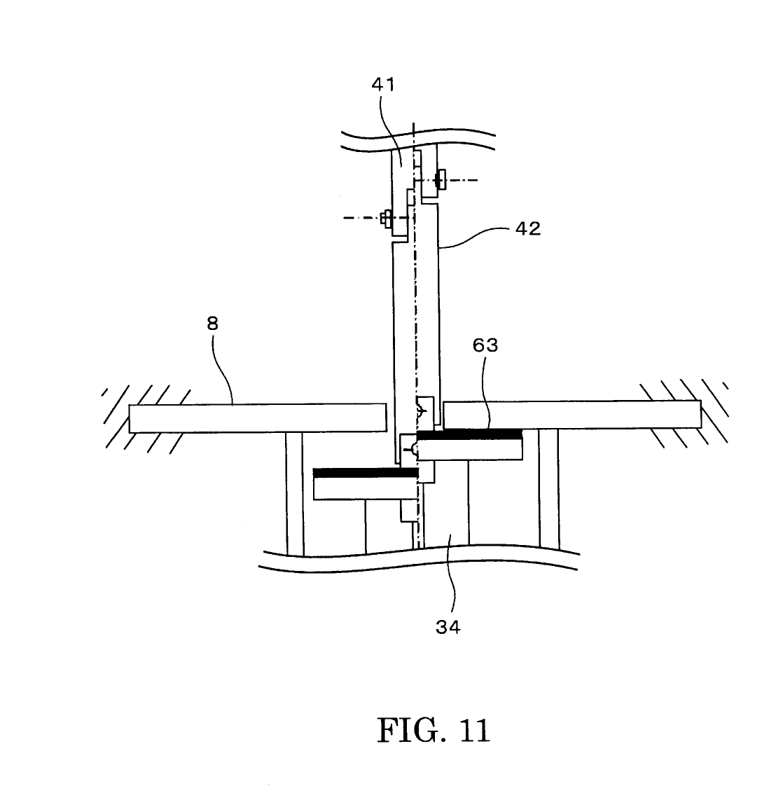

FIG. 11 is a constructional diagram showing a first holding mechanism 6 of a power switch 1 according to a third embodiment. The left half of the Figure shows the cut-off condition and the right half of the Figure shows the closed condition. As shown in FIG. 11, in this first holding mechanism 6, a frame 8 replaces the target 62. Specifically, the frame 8 is formed of a ferromagnetic body. Furthermore, a plate-shaped rubber magnet 63 that raised from the peripheral surface is fixed to the intermediate rod 42.

(Action/Beneficial Effect)

With this first holding mechanism 6, as shown in the right-hand part of FIG. 11, the rubber magnet 63 is in contact with the frame 8. The strong magnetic attractive force of the rubber magnet 63 therefore acts on the frame 8, fixing the rubber magnet 63 to the frame 8.

The rubber magnet 63 and the outer ring 34 are in a fixed relationship and the outer ring 34 and the movable contact 52 are in a linked relationship, through the intermediate rod 42 and the operating rod 41, so the movable contact 52 is also maintained in the closed position. Consequently, in the condition in which the operating mechanism 3 is stationary, even if an external force such as weight acts on the movable contact 52, the operating mechanism 3 will maintain its closed condition, without continued actuation. As a result, in the first holding mechanism 6 according to the present embodiment, regardless of the mechanical system, power for maintaining the closed condition is not necessary. Furthermore, since the rubber magnet 63 provides a high resilient force, collision shock of the rubber magnet 63 and the frame 8 is buffered so that the risk of malfunction can be further reduced. Also, since construction designed to reduce the risk of malfunction can be eliminated; further reduction in weight can be achieved.

### OTHER EMBODIMENTS

While various embodiments of the present invention have been described above, these embodiments are presented merely by way of example and are not intended to restrict the scope of the invention. Specifically, combinations of all or some of the first to the third embodiments are included. The above embodiments can be put into practice in various other forms and various deletions or substitutions or modifications may be effected in a range not departing from the scope of the invention. Such embodiments or modifications thereof are included in the scope or gist of the invention and, likewise, are included in the invention as set out in the scope of the patent claims and equivalents thereof.

For example, whereas in the Figures examples were shown in which the power switch 1 is horizontal, the power switch 1 could be arranged vertically. Also, examples were described in which the external permanent magnets and internal permanent magnets were ring-shaped, but they could be arcuate-shaped and arranged in ring shape.

1: A power switch operating mechanism for moving a switch device between a cut-off condition and a closed condition by reciprocating drive of a movable contact, said power switch operating mechanism comprising:
a series of first permanent magnets constituted by arranging these permanent ring-shaped or arcuate-shaped magnets adjacently wherein magnetic poles of these permanent magnets are rotated by a maximum of 90° in each case in a cross-section including a central axis thereof;
a series of second permanent magnets wherein magnetic poles of these ring-shaped or arcuate-shaped permanent magnets have a magnetization vector radial component in a same direction as said series of first permanent magnets or have a magnetization vector axial component in an opposite direction to that of said series of first permanent magnets;
a magnet fixing means for fixing said series of first permanent magnets and said series of second permanent magnets so that magnetization vector radial components of their respective magnetic poles face in a same direction;
a coil that is interposed between said series of first permanent magnets and said second series of permanent magnets with a fixed clearance;
a coil support means for being directly or indirectly linked with said movable contact so that said coil is fixed and is capable of parallel movement along said series of first and second permanent magnets; and
a power supply lead that supplies power for exciting said coil,
whereby thrust for reciprocating drive of said movable contact is generated by an action of said excited coil and a magnetic circuit generated by said series of first permanent magnets and said series of second permanent magnets.

2: The power switch operating mechanism according to claim 1,
wherein first permanent magnets and second permanent magnets hold equivalent magnetic energy.

3: The power switch operating mechanism according to claim 1, further comprising:
a ferromagnetic body that is fixed to said coil support means or a member that moves linked with said coil support means; and
a third permanent magnet whose position is fixed;
wherein a position of said movable contact is maintained by a magnetic attractive force of said third permanent magnet with respect to said ferromagnetic body, by relative approach of said ferromagnetic body and said third permanent magnet in response to movement of said coil support means.

4: The power switch operating mechanism according to claim 1, further comprising:
a third permanent magnet that is fixed to said coil support means or a member that moves linked with said coil support means; and
a ferromagnetic body whose position is fixed;
wherein a position of said movable contact is maintained by a magnetic attractive force of said third permanent magnet with respect to said ferromagnetic body, by relative approach of said ferromagnetic body and said third permanent magnet in response to movement of said coil support means.

5: The power switch operating mechanism according to claim 3,
wherein said third permanent magnet is a rubber magnet.

6: The power switch operating mechanism according to claim 4,
wherein said third permanent magnet is a rubber magnet.

7: The power switch operating mechanism according to claim 1, further comprising
a ferromagnetic body fixed to said coil support means,
wherein leakage magnetic flux generated from said series of first permanent magnets and said series of second permanent magnets acts as a magnetic attractive force on said ferromagnetic body, so that a position of said movable contact is maintained.

8: The power switch operating mechanism according to claim 1, further comprising:
an operating rod that produces reciprocating movement of said movable contact; and
a lever having a fixed point that is capable of rotation at one end thereof, said coil support means being rotatably mounted directly or indirectly at the other end thereof, and said operating rod being mounted at a location closer to said fixed point than said coil support means, whereby a thrust of said coil support means is amplified before being transmitted to said movable contact.

9: The power switch operating mechanism according to claim 1, further comprising:
an operating rod that produces reciprocating movement of said movable contact; and
a lever having a fixed point that is capable of rotation at one end thereof, said operating rod being rotatably mounted at the other end thereof, and said coil support means being directly or indirectly mounted at a location closer to said fixed point than said operating rod, whereby an amount of movement of said coil support means is amplified before being transmitted to said movable contact.

10: A power switch that is a switch device comprising:
a movable contact capable of reciprocating movement; and
an operating mechanism that drives said movable contact,
wherein movement between a cut-off condition and a closed condition can be effected by moving said movable contact, and
wherein said operating mechanism is an operating mechanism according to claim 1.

11: The power switch operating mechanism according to claim 2, further comprising:
a ferromagnetic body that is fixed to said coil support means or a member that moves linked with said coil support means; and
a third permanent magnet whose position is fixed;
wherein a position of said movable contact is maintained by a magnetic attractive force of said third permanent magnet with respect to said ferromagnetic body, by relative approach of said ferromagnetic body and said third permanent magnet in response to movement of said coil support means.

12: The power switch operating mechanism according to claim 2, further comprising:
a third permanent magnet that is fixed to said coil support means or a member that moves linked with said coil support means; and
a ferromagnetic body whose position is fixed;

13: The power switch operating mechanism according to claim 2, further comprising
a ferromagnetic body fixed to said coil support means,
wherein leakage magnetic flux generated from said series of first permanent magnets and said series of second permanent magnets acts as a magnetic attractive force on said ferromagnetic body, so that a position of said movable contact is maintained.

14: The power switch operating mechanism according to claim 2, further comprising:
an operating rod that produces reciprocating movement of said movable contact; and
a lever having a fixed point that is capable of rotation at one end thereof, said coil support means being rotatably mounted directly or indirectly at the other end thereof, and said operating rod being mounted at a location closer to said fixed point than said coil support means, whereby a thrust of said coil support means is amplified before being transmitted to said movable contact.

15: A power switch that is a switch device comprising:
a movable contact capable of reciprocating movement; and
an operating mechanism that drives said movable contact,
wherein movement between a cut-off condition and a closed condition can be effected by moving said movable contact, and
wherein said operating mechanism is an operating mechanism according to claim 2.
